(19) United States
(12) Patent Application Publication
(10) Pub. No.: US 2025/0086833 A1
(43) Pub. Date: Mar. 13, 2025

(54) METHOD AND DEVICE WITH 3D RECONSTRUCTION

(71) Applicant: Samsung Electronics Co., Ltd., Suwon-si (KR)

(72) Inventors: Zhihua LIU, Beijing (CN); Xiongfeng PENG, Beijing (CN); Zhitong YE, Beijing (CN); Qiang WANG, Beijing (CN); SoonYong CHO, Suwon-si (KR); Young Hun SUNG, Suwon-si (KR)

(73) Assignee: Samsung Electronics Co., Ltd., Suwon-si (KR)

(21) Appl. No.: 18/825,873

(22) Filed: Sep. 5, 2024

(30) Foreign Application Priority Data
Sep. 8, 2023 (CN) 202311160890.8
Jul. 16, 2024 (KR) 10-2024-0093793

(51) Int. Cl. G06T 7/73; G06T 15/20; G06V 10/40; G06V 10/82; G06V 20/40

(52) U.S. Cl. CPC G06T 7/75; G06T 15/20; G06V 10/513; G06V 10/82; G06V 20/40; G06T 2207/30244; G06T 2215/12

(57) ABSTRACT

A method performed by an electronic device, the electronic device, and a storage medium are provided. The method includes obtaining a frame image of a video from a camera and inertia data of an inertial measurement unit (IMU) corresponding to the frame image and obtaining a camera position and pose of the camera, a sparse map, and a high-density map corresponding to the frame image, based on the frame image and the inertia data of the IMU.

### CROSS-REFERENCE TO RELATED APPLICATIONS

This application claims the benefit under 35 USC § 119 (a) of Chinese Patent Application No. 202311160890.8, filed on Sep. 8, 2023, in the China National Intellectual Property Administration, and Korean Patent Application No. 10-2024-0093793 filed on Jul. 16, 2024, in the Korean Intellectual Property Office, the entire disclosure of which is incorporated herein by reference for all purposes.

### BACKGROUND

### 1. Field

The following description relates to a method performed by an electronic device related to location measurement and mapping, the electronic device, and a storage medium.

### 2. Description of Related Art

The most commonly used hardware in the augmented reality (AR)/virtual reality (VR) field includes image sensors and inertial measurement unit (IMU) sensors. An image sensor may collect image information from the real world in real time, and an IMU sensor may collect high-frequency angular velocity and acceleration information. Based on this information, existing simultaneous localization and mapping (SLAM) technology generally extracts feature points of a scene first, measures a location through data correlation, and then builds a sparse map. Accordingly, the existing SLAM technology may be quickly applied to a new scene without a pre-trained model.

However, the SLAM technology may obtain only a sparse map that cannot recognize structure and details of a scene sufficient to obtain a real-time camera position and pose, and thus, interaction between reality and virtual reality is impossible in certain AR interaction areas. For example, when a virtual object is arranged behind a real object, virtual-reality occlusion cannot be achieved.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure provides a method performed by an electronic device, the electronic device, and a storage medium.

In one general aspect, a method performed by an electronic device includes obtaining a frame image of a video from a camera and data of an inertial measurement unit (IMU) corresponding to the frame image, the data of the IMU indicating inertial movement corresponding to the frame image, and obtaining a camera position and pose of the camera, a sparse map, and a high-density map corresponding to the frame image, based on the frame image and the data of the IMU.

The obtaining of the camera position and pose, the sparse map, and the high-density map corresponding to the frame image may include, in response to the frame image being a key frame, obtaining the camera position and pose corresponding to the frame image, a three-dimensional (3D) landmark point, a speed of the IMU, and a deviation of the IMU, based on the frame image and the data of the IMU, performing global optimization based on the camera position and pose corresponding to at least one key frame including the frame image, the 3D landmark point, the speed of the IMU, and the deviation of the IMU, generating the sparse map corresponding to the frame image from an optimized 3D landmark point, and obtaining the high-density map through a neural network, based on a result of the global optimization, a depth map corresponding to the frame image, and the frame image.

The obtaining of the camera position and pose, the sparse map, and the high-density map corresponding to the frame image may include, based on the frame image being a non-key frame, obtaining the camera position and pose of the frame image, based on the frame image and the data of the IMU corresponding to the frame image, and determining the sparse map and the high-density map corresponding to a previous key frame before the frame image as the sparse map and the high-density map corresponding to the frame image.

The performing of the global optimization based on the camera position and pose corresponding to at least one key frame including the frame image, the 3D landmark point, the speed of the IMU, and the deviation of the IMU may include constructing a reprojection error function based on a robust kernel function, based on the camera position and pose corresponding to the at least one key frame and the 3D landmark point, constructing an error function of the IMU, based on the camera position and pose corresponding to the at least one key frame, the speed of the IMU, and the deviation of the IMU, and by minimizing a global optimization target function including the reprojection error function based on the robust kernel function and the error function of the IMU, obtaining an optimized camera position and pose corresponding to the at least one key frame, an optimized 3D landmark point, an optimized speed of the IMU, and an optimized deviation of the IMU.

The robust kernel function may include a Huber kernel function.

The obtaining of the camera position and pose, the sparse map, and the high-density map corresponding to the frame image may include, based on the frame image being a non-key frame, determining a depth map corresponding to the frame image.

The determining of the depth map corresponding to the frame image may include performing stereo matching on a left image and a right image of the frame image to obtain a binocular disparity map corresponding to the frame image and converting the binocular disparity map to obtain the depth map corresponding to the frame image.

The performing of the stereo matching on the left image and the right image of the frame image to obtain the binocular disparity map corresponding to the frame image may include obtaining the binocular disparity map by performing stereo matching according to a high-density map corresponding to a previous key frame before the frame image and the left eye image and the right eye image of the frame image.

The obtaining of the high-density map through the neural network, based on the result of the global optimization, the depth map corresponding to the frame image, and the frame image may include obtaining an implicit high-density map representation of a scene corresponding to a binocular video by training the neural network based on the result of the global optimization, the depth map corresponding to the frame image, and the frame image, and obtaining reliability of the high-density map and each 3D landmark point in the high-density map by inputting an optimized camera position and pose corresponding to the frame image to the obtained implicit high-density map representation.

The obtaining of the implicit high-density map representation of the scene corresponding to the binocular video by training the neural network based on the result of the global optimization, the depth map corresponding to the frame image, and the frame image may include obtaining a rendered color image and a rendered depth map based on the optimized camera position and pose corresponding to the frame image, determining a first loss function based on the rendered color image and a color image of the frame image, determining a second loss function based on the rendered depth map and the depth map, determining a third loss function based on the depth map and the color image of the frame image, and obtaining the implicit high-density map representation of the scene by training the neural network based on a weight sum of the first loss function, the second loss function, and the third loss function.

The obtaining of the camera position and pose, the sparse map, and the high-density map corresponding to the frame image may include, based on the frame image being a key frame, updating the sparse map based on reliability of the high-density map and each 3D landmark point in the high-density map.

The updating of the sparse map may include, for one 3D landmark point in the sparse map, according to reliability of a 3D landmark point corresponding to the one 3D landmark point in the high-density map, determining a first weight of the one 3D landmark point and a second weight of the 3D landmark point corresponding to the one 3D landmark point in the high-density map, based on the determined first weight and the determined second weight, updating the one 3D landmark point by fusing the one 3D landmark point with the 3D landmark point corresponding to the one 3D landmark point in the high-density map, and updating the sparse map by performing the determining of the first weight and the second weight and the updating of the one 3D landmark point, for each 3D landmark point in the sparse map.

A non-transitory computer-readable storage medium may store instructions that, when executed by a processor, cause the processor to perform the method.

In another general aspect, an electronic device includes one or more processors and a memory storing instructions configured to cause the one or more processors to: obtain a frame image of a video from a camera and inertia data of an IMU corresponding to the frame image and obtain a camera position and pose of the camera, a sparse map, and a high-density map corresponding to the frame image, based on the frame image and the inertia data of the IMU.

When executed by the one or more processors, the instructions may cause the electronic device to, in the obtaining of the camera position and pose, the sparse map, and the high-density map corresponding to the frame image, based on the frame image being a key frame, obtain the camera position and pose corresponding to the frame image, a 3D landmark point, a speed of the IMU, and a deviation of the IMU, based on the frame image and the inertia data of the IMU, perform global optimization based on the camera position and pose corresponding to at least one key frame including the frame image, the 3D landmark point, the speed of the IMU, and the deviation of the IMU, generate the sparse map corresponding to the frame image from an optimized 3D landmark point, and obtain the high-density map through a neural network, based on a result of the global optimization, a depth map corresponding to the frame image, and the frame image.

When executed by the one or more processors, the instructions may cause the electronic device to, in the obtaining of the camera position and pose, the sparse map, and the high-density map corresponding to the frame image, based on the frame image being a non-key frame, obtain the camera position and pose of the frame image, based on the frame image and the inertia data of the IMU corresponding to the frame image, and determine the sparse map and the high-density map corresponding to a previous key frame before the frame image as the sparse map and the high-density map corresponding to the frame image.

When executed by the one or more processors, the instructions may cause the electronic device to, in the performing of the global optimization based on the camera position and pose corresponding to at least one key frame including the frame image, the 3D landmark point, the speed of the IMU, and the deviation of the IMU, construct a reprojection error function based on a robust kernel function, based on the camera position and pose corresponding to the at least one key frame and the 3D landmark point, construct an error function of the IMU, based on the camera position and pose corresponding to the at least one key frame, the speed of the IMU, and the deviation of the IMU, and by minimizing a global optimization target function including the reprojection error function based on the robust kernel function and the error function of the IMU, obtain an optimized camera position and pose corresponding to the at least one key frame, an optimized 3D landmark point, an optimized speed of the IMU, and an optimized deviation of the IMU.

When executed by the one or more processors, the instructions may cause the electronic device to, in the obtaining of the camera position and pose, the sparse map, and the high-density map corresponding to the frame image, based on the frame image being a non-key frame, perform stereo matching on a left eye image and a right eye image of the frame image to obtain a binocular disparity map corresponding to the frame image, and convert the binocular disparity map to obtain the depth map corresponding to the frame image.

When executed by the one or more processors, the instructions cause the electronic device to, in the obtaining of the high-density map through the neural network, based on the result of the global optimization, the depth map corresponding to the frame image, and the frame image, obtain an implicit high-density map representation of a scene corresponding to a binocular video by training the neural network based on the result of the global optimization, the depth map corresponding to the frame image, and the frame image, and obtain reliability of the high-density map and each 3D landmark point in the high-density map by inputting an optimized camera position and pose corresponding to the frame image to the obtained implicit high-density map representation.

When executed by the one or more processors, the instructions cause the electronic device to, in the obtaining of the camera position and pose, the sparse map, and the high-density map corresponding to the frame image, based on the frame image being a key frame, for one 3D landmark point in the sparse map, according to reliability of a 3D landmark point corresponding to the one 3D landmark point in the high-density map, determine a first weight of the one 3D landmark point and a second weight of the 3D landmark point corresponding to the one 3D landmark point in the high-density map, based on the determined first weight and the determined second weight, update the one 3D landmark point by fusing the one 3D landmark point with the 3D landmark point corresponding to the one 3D landmark point in the high-density map, and update the sparse map by performing the determining of the first weight and the second weight and the updating of the one 3D landmark point, for each 3D landmark point in the sparse map.

Other features and aspects will be apparent from the following detailed description, the drawings, and the claims.

### BRIEF DESCRIPTION OF THE DRAWINGS

FIG. 1 illustrates an example of a method performed by an electronic device, according to one or more embodiments.

FIG. 2 illustrates an example of a detailed method performed by an electronic device, according to one or more embodiments.

FIG. 3 illustrates an example of a system corresponding to a method performed by an electronic device, according to one or more embodiments.

FIG. 4 illustrates an example of a training method using a neural radiance field (NeRF), according to one or more embodiments.

FIG. 5 illustrates an example structure of an electronic device to which an example of the present disclosure is applied, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

At least some functions of the device or electronic device in examples of the present disclosure may be implemented through an artificial intelligence (AI) model, and for example, at least one of modules of the device or electronic device may be implemented through an AI model. AI-related functions may be performed by a non-volatile memory, a volatile memory, and a processor.

The processor may include one or more processors. In this case, the one or more processors may be a general purpose processor (e.g., a central processing unit (CPU), an application processor (AP)), a graphics-only processing unit (e.g., a graphics processing unit (GPU) and a vision processing unit (VPU)), and/or an AI-only processor (e.g., a neural processing unit (NPU)).

The one or more processors may control the processing of input data based on a predefined operation rule or AI model stored in the non-volatile memory and the volatile memory. The predefined operation rule or AI model may be provided through training or learning of the AI model.

Here, providing the predefined operation rule or the AI model through learning may involve obtaining a predefined operation rule or an AI model having desired characteristics by applying a learning algorithm to pieces of training data. The training may be performed by an electronic device having an AI function according to an example, or by a separate server, device, and/or system that provides the AI model to another device for use thereby.

The AI model may include neural network layers. Each layer may include a set of weight values, and each layer may performs neural network calculation by calculating between input data of a corresponding layer (e.g., a calculation result of a previous layer and/or input data of the AI model) and weight values of a current layer. Examples of a neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q-network, as non-limiting examples.

The learning algorithm may be a method of training a predetermined target device, for example, a robot, based on pieces of training data and of enabling, allowing, or controlling the predetermined target device to perform determination or prediction after being trained. The learning algorithm may include, but is not limited to, for example, supervised learning, unsupervised learning, semi-supervised learning, or reinforcement learning.

The method provided in the present disclosure may be applied to one or several fields of technology, such as voice, language, image, video, or data intelligence.

Optionally, with regard to the field of voice or language, in a method performed by an electronic device according to the present disclosure, a voice signal may be received as an analog signal through a voice input device (e.g. a microphone) and a portion of the voice may be converted into computer-readable text using an automatic speech recognition (ASR) model. Speech intention of a user may be obtained by interpreting the converted text using a natural language understanding (NLU) model. An ASR model or an NLU model may be an AI model (e.g., neural networks). An AI model may be processed by an AI-specific processor designed with a hardware architecture designated for AI model processing. Linguistic understanding is a technique of recognizing and applying/processing human language/texts and includes natural language processing, machine translation, dialogue system, question and answer, and speech recognition/synthesis.

Optionally, with respect to the image or video field of application, in a method performed by an electronic device according to the present disclosure, image data may be used as input data of an AI model to obtain output data. The method of the present disclosure may be related to the field of AI technology of viewing angle understanding, which is technology of recognizing and processing things such as a human viewing angle, and may include, for example, object recognition, object tracking, image search, person recognition, scene recognition, three-dimensional (3D) reconstruction/positioning or image enhancement.

Optionally, with respect to the field of data intelligence processing, in a method performed by an electronic device according to the present disclosure, in an inference or prediction operation, an AI model may be used to perform prediction using real-time input data. A processor of an electronic device may perform a preprocessing operation on data and may convert the data into a form suitable for use as input to an AI model. Inference prediction is a technique of judging information and performing logical inference to provide a prediction and includes, for example, knowledge-based inference, optimization prediction, preference-based planning, or recommendation.

In the present disclosure, the AI model may be obtained through training. In this case, “obtaining through training” may involve training the AI model configured to execute a predefined operating rule or a required feature (or objective) by training a basic AI model with various pieces of training data through a training algorithm. The AI model may include neural network layers. Each of the neural network layers may include a respective set of weight values, and a neural network computation may be performed by a calculation between a calculation result from a previous layer and the weight values of a current layer.

As described in the description of the related art, some algorithms exist that may obtain a camera position and pose and a high-density map to achieve virtual and real occlusion functions, but the accuracy of the camera position and pose and the high-density map obtained by these algorithms is low and real-time execution on a CPU or a terminal is not possible.

For example, a real-time monocular visual simultaneous localization and mapping (SLAM) algorithm with oriented FAST and rotated BRIEF (ORB) features and a neural radiance field (NeRF)-realized mapping (Orbeez-SLAM) may be combined with a NeRF network based on an existing SLAM algorithm to output the camera position and pose and the high-density map in real time. The algorithm utilizes an existing SLAM to output real-time camera positions, poses, and sparse maps, takes these pieces of data and a corresponding red, green, and blue (RGB) image as input, and uses a NeRF method to learn a structure of a multilayer perceptron (MLP) network, thereby learning an implicit representation of a 3D scene. In this case, given one viewing angle, based on the implicit representation of the corresponding 3D scene, the NeRF network may output an RGB image according to the corresponding viewing angle. However, a differential recurrent optimization-inspired design-SLAM (Orbeez-SLAM) algorithm is simply the addition of a teleport SLAM algorithm and the NeRF network without deep fusion. Specifically, the Orbeez-SLAM algorithm does not apply a high-density map obtained by the NeRF network to a position and pose calculation and sparse map reconstruction of the SLAM algorithm.

For example, a NeRF-SLAM algorithm integrates droid-SLAM, which is a deep learning-based SLAM algorithm, and the NeRF network into an end-to-end deep framework and the NeRF-SLAM algorithm utilizes the output of a high-density depth map obtained from the droid-SLAM to supervise the NeRF network. Specifically, the NeRF-SLAM algorithm obtains an optical stream and reliability of the optical stream through a convolution gated recurrent unit (GRU), based on an input monocular video stream, and then constructs a Hessian matrix to decompose the Hessian matrix using a square root method (i.e., Cholesky), thereby obtaining a relative position and pose, a position, and reliability of the pose. Subsequently, the NeRF-SLAM algorithm inputs the obtained data into the NeRF network for training and the NeRF network supervises using RGB images and depth. Although the NeRF-SLAM algorithm may output both camera position and pose and a high-density implicit map, the NeRF-SLAM algorithm integrates the droid-SLAM, which is a deep learning-based SLAM algorithm, and the NeRF network into an end-to-end depth framework, and thus, the NeRF-SLAM algorithm may not be executed in real time on a CPU or a terminal.

To further improve the accuracy of a camera position and pose, an implicit high-density map representation, a high-density map, and/or a sparse map obtained by a conventional SLAM algorithm, some examples of the present disclosure propose an idea of deeply integrating a conventional SLAM algorithm, binocular depth estimation, and a NeRF method.

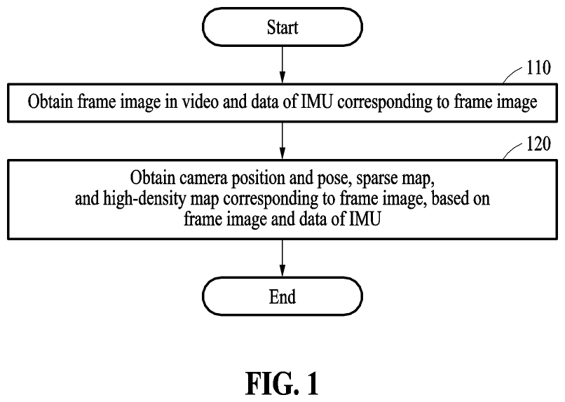

Hereinafter, a method performed by an electronic device, the electronic device, and a storage medium according to an example of the present disclosure are described in detail with reference to FIGS. 1 to 5. The following implementation methods may be cross-referenced, referenced, or combined, and the same terminology, similar functions, and similar implementation operations among different implementation methods are not repeatedly described.

FIG. 1 illustrates an example of a schematic method performed by an electronic device, according to one or more embodiments.

Referring to FIG. 1, in operation 110, an electronic device may obtain a frame image in a video and data of an inertial measurement unit (IMU) (also referred to as an IMU data stream) corresponding to the frame image. Here, the video may be a binocular video obtained by capturing one scene using a binocular camera, etc. In the present disclosure, a binocular video may also be referred to as a binocular video stream, a stereoscopic video stream, and a stereoscopic video. In addition, in the present disclosure, the frame image may include a left image and a right image.

In operation 120, the electronic device may obtain a camera position and pose, a sparse map, and a high-density map (e.g., a cloud map) corresponding to the frame image, based on the frame image and the data of the IMU.

In an example of the present disclosure, the frame image may be a key frame or a non-key frame (also referred to as a normal frame). In an example of the present disclosure, the key frame and the non-key frame may be determined in a binocular video using any known key frame selection method related to SLAM-related technology and any key frame selection method that may emerge in the future, but the present disclosure is not limited thereto.

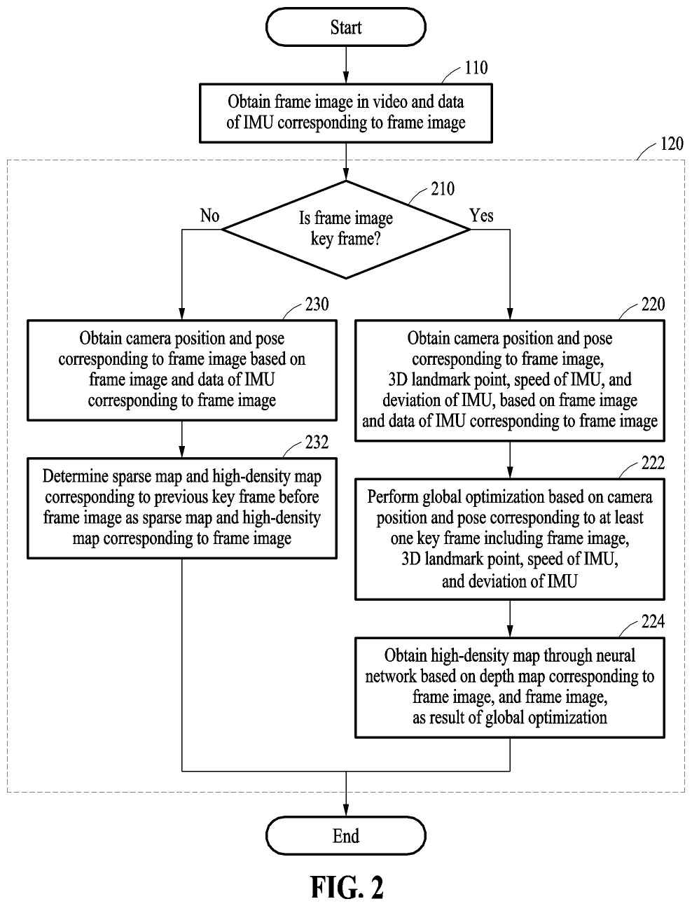

Hereinafter, with reference to FIG. 2, when frame images are the key frame and the non-key frame, respectively, a process of obtaining a camera position and pose, a sparse map, and a high-density map corresponding to the frame image based on the frame image and the data of the IMU corresponding to the frame image is described.

FIG. 2 illustrates an example of a detailed method performed by an electronic device, according to one or more embodiments.

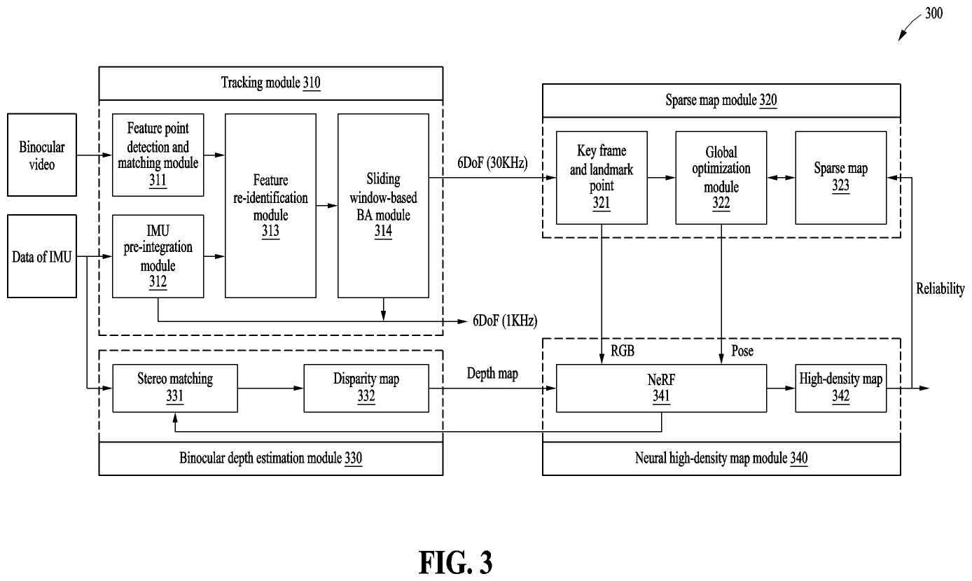

FIG. 3 illustrates an example of a system corresponding to a method performed by an electronic device, according to one or more embodiments.

Specifically, the methods shown in FIGS. 1 and 2 may be executed by an electronic device 300 shown in FIG. 3 and the electronic device 300 may include four main modules, which are a tracking module 310, a sparse map module 320, a binocular depth estimation module 330, and a neural high-density map module 340; each may be executed by different threads.

First, in operation 110, the electronic device 300 may obtain a frame image of a video and data of an IMU corresponding to the frame image. As shown in FIG. 3, the frame image of the video and the data of the IMU may be input to the electronic device 300 of FIG. 3. Operation 110 is described in detail with reference to FIG. 1, so the description thereof is not repeated.

In operation 210, the electronic device 300 may determine whether the frame image is a key frame or a non-key frame. When the frame image is the key frame, the electronic device 300 may execute operations 220 to 224. That is, when the frame image is the key frame, operation 120 of FIG. 1 may include operations 220 to 224.

First, when the frame is a key image, in operation 220, the electronic device 300 may obtain a camera position and pose corresponding to the frame image, a 3D landmark point, a speed of the IMU, and a deviation of the IMU, based on the frame image and the data of the IMU corresponding to the frame image. In the present disclosure, a 3D landmark point corresponding to a frame image may be a point observable from the frame image. In addition, in the present disclosure, a 3D landmark point may be referred to as a 3D point.

As shown in FIG. 3, the frame image of the video and the data of the IMU corresponding to the frame image may be input to the tracking module 310. The tracking module 310 may include a feature point detection and matching module 311, an IMU pre-integration module 312, a feature re-identification module 313, and a sliding window-based bundle adjustment (BA) module 314. Specifically, the feature point detection and matching module 311 may perform feature point detection in the frame image of the input video and then may match feature points detected in a left image and a right image of the frame image. The IMU pre-integration module 312 may perform a pre-integration operation on the data of the IMU corresponding to the frame image, thereby obtaining an IMU speed and a deviation. The feature re-identification module 313 may identify whether a newly detected feature point is a point of a global sparse map, may associate a newly extracted feature point with the sparse map when the newly extracted feature point is a point of the sparse map, and otherwise may not associate the newly extracted feature point with the sparse map. The corresponding operation may effectively improve accuracy of the algorithm, and in the present disclosure, the sparse map is a globally consistent map that may be optimized and/or updated in the sparse map module 320 as described below. Subsequently, the sliding window-based BA module 314 may perform BA optimization on consecutive video frames in a time domain, the 3D landmark point, and the data of the IMU within the time domain to obtain a camera position and pose having consistent time domain. The consecutive video frames may include the key frame and/or the non-key frame. In addition, the 3D landmark point may include not only the landmark point of the sparse map but also the 3D landmark point obtained by triangulating the frame image. The tracking module 310 may obtain the camera position and pose at a frame frequency for the binocular video by performing an operation on each frame of the binocular video according to the process described above to obtain the camera position and pose for each frame. In this case, based on an output result of the IMU pre-integration module 312 and the camera position and pose (e.g., a 6 degrees of freedom (DoF) camera position and pose at 30 hertz (Hz)) at a frame frequency output by the sliding window-based BA module 314, the camera position and pose at an IMU frequency (e.g., a 6DoF camera position and pose at 1 kilohertz (kHz)) may be obtained. For example, the camera position and pose at the IMU frequency may be obtained through an interpolation method, but the present disclosure is not limited thereto, and other methods may be used.

In addition, the tracking module 310 may also obtain (e.g., may simultaneously obtain) a new observed 3D landmark point (specifically, a 3D coordinate of a landmark point) from each frame and may determine the key frame according to the number of tracked feature points. For example, when the number of tracked feature points in one frame is less than a predetermined threshold value (in this case, the threshold value may be set), the tracking module 310 may determine the one frame as the key frame and otherwise may determine the one frame as the non-key frame. That is, the tracking module 310 may determine (or select) each frame in the binocular video as a key frame and a non-key frame.

Through the description, the tracking module 310 may determine the camera position and pose for each frame, an observable 3D landmark point, the speed of the IMU, and the deviation of the IMU. The tracking module 310 described above may adopt a tracking algorithm within an existing SLAM algorithm. For example, there are ORB-SLAM and open keyframe-based visual-inertial SLAM (OKVIS) and in the present disclosure, description thereof is not repeated.

In operation 222, the electronic device 300 may perform global optimization based on the camera position and pose corresponding to at least one key frame including the frame image, the 3D landmark point, the speed of the IMU, and the deviation of the IMU. As shown in FIG. 3, the global optimization module 322 of the sparse map module 320 may perform global optimization using the camera position and pose corresponding to at least one key frame (a frame image), a 3D landmark point 321 (that is, the 3D landmark point of a current sparse map), the speed of the IMU, and the deviation of the IMU. As a result, the global optimization module 322 may obtain an optimized camera position and pose corresponding to at least one key frame, an optimized 3D landmark point, an optimized speed of the IMU, and an optimized deviation of the IMU. A sparse map corresponding to a currently input frame image may be generated based on the optimized 3D landmark point.

Specifically, operation 222 may include constructing a reprojection error function based on a robust kernel function, based on the camera position and pose corresponding to the at least one key frame and the 3D landmark point, constructing an error function of the IMU, based on the camera position and pose corresponding to at least one key frame, the speed of the IMU, and the deviation of the IMU, and by minimizing a global optimization target function (which includes the reprojection error function) based on the robust kernel function and the error function of the IMU, obtaining an optimized camera position and pose corresponding to at least one key frame, an optimized 3D landmark point, an optimized speed of the IMU, and an optimized deviation of the IMU. The sparse map corresponding to the frame image obtained in operation 120 may be generated according to the optimized 3D landmark point.

Specifically, the electronic device 300 may construct the reprojection error function based on the robust kernel function, based on the camera position and pose corresponding to the at least one key frame and the 3D landmark point, as shown in Equation 1 below.

$${E}_{1} = {\sum }_{i = {k}_{1}}^{{k}_{m}} {\sum }_{j ∈ {V}_{i}} ‖ {E}_{ij} ( {T}_{i} , {T}_{{s}_{j}} , {x}_{j} ) ‖ \qquad Equation 1$$

Here, E₁ denotes the reprojection error function, kₘ denotes the number of the at least one key frame, k₁ denotes a first key frame, Vᵢ denotes an index set of a 3D landmark point that is newly generated in an I-th key frame (e.g., an index set of a 3D landmark point that may newly appear in the I-th key frame), Eᵢⱼ denotes a reprojection error of a j-th 3D landmark point in the I-th key frame, Tᵢ denotes a camera position and pose corresponding to an i-th key frame, Tₛⱼ denotes a camera position and pose corresponding to an sj-th key frame, and Xⱼ denotes a 3D coordinate of a j-th 3D landmark point.

In an example of the present disclosure, when constructing the reprojection error function, the present disclosure uses the robust kernel function to improve stability and the constructed reprojection error function may be based on the robust kernel function (e.g., a Huber function). A specific calculation process is as shown in Equation 2 below, and Equation 3 is the definition of the Huber function. Here, b is a hyperparameter that may be set to a real number greater than 0. For example, b may be set to 1.

$$\begin{matrix}\{ {T}_{i} , {X}_{j} \} = arg min \sum ρ ( {‖ {\underbrace{{z}_{k} - π ( {T}_{i} , {X}_{j} )}}_{{E}_{ij}} ‖}_{\sum }^{2} ) \\ = arg min \sum ρ ( {E}_{ij}^{T} {\sum }^{- 1} {E}_{ij} )\end{matrix} \qquad Equation 2$$

$$ρ = \{ \begin{matrix}x , & if \sqrt{x} < b \\ 2 b \sqrt{x} - {b}^{2} , & else\end{matrix} \qquad Equation 3$$

Here, Zₖ denotes the measurement of a k-th key frame (i.e., a feature point of the k-th key frame), ∥·∥_{Σ} denotes a Mahalanobis distance function, and Σ denotes an information matrix. In an example of the present disclosure, the influence of outliers on optimization may be reduced by using the Huber kernel function to act on the reprojection error of all feature points.

Alternatively, the present disclosure may construct an IMU error function based on the camera position and pose corresponding to the at least one key frame, the speed of the IMU, and the deviation of the IMU, as shown in Equation 4 below.

$${E}_{2} = {\sum }_{i = {k}_{1}}^{{k}_{m} - 1} ‖ {E}_{i , i + 1}^{imu} ( {M}_{i} , {M}_{i + 1} , {T}_{i} , {T}_{i + 1} ) ‖ \qquad Equation 4$$

Here, E₂ denotes the IMU error function, E_{i,i+1}^{imu} denotes an IMU error of the i-th key frame and an i+1-th key frame, Mᵢ and Mᵢ₊₁ denote the IMU speed and deviation corresponding to the i-th key frame and the IMU speed and deviation corresponding to the i+1-th key frame, respectively, and Tᵢ and Tᵢ₊₁ denote the camera position and pose corresponding to the i-th key frame and the camera position and pose corresponding to the i+1-th key frame, respectively.

Subsequently, the present disclosure may construct a global optimization target function with the reprojection error function and the IMU error function based on the robust kernel function, as shown in Equation 5 below.

$${arg min}_{{T}_{i} , {M}_{i} , {X}_{j}} {\sum }_{i = {k}_{1}}^{{k}_{m}} {\sum }_{j ∈ {V}_{i}} ‖ {E}_{ij} ( {T}_{i} , {T}_{{s}_{j}} , {X}_{j} ) ‖ + {\sum }_{i = {k}_{1}}^{{k}_{m} - 1} ‖ {E}_{i , i + 1}^{imu} ( {M}_{i} , {M}_{i + 1} , {T}_{i} , {T}_{i + 1} ) ‖ \qquad Equation 5$$

An optimization amount of the global optimization target function shown in Equation 5 may include the camera position and pose corresponding to the at least one key frame (including a current frame image), the speed of the IMU, the deviation of the IMU, and the 3D landmark point. In this case, a solution to Equation 5 is obtained through minimization of the global optimization target function, and through this, the optimized camera position and pose corresponding to the at least one key frame and the optimized 3D landmark point may be obtained. In addition, the sparse map (e.g., the global sparse map in this case) corresponding to an image of the current frame may be generated according to the optimized 3D landmark point.

Referring to FIG. 2, in operation 224, the electronic device 300 may obtain a high-density map through a neural network based on the depth map corresponding to the frame image, and the frame image, as a result of the global optimization.

Before performing operation 224, the electronic device 300 may determine the depth map corresponding to the frame image.

For example, the electronic device 300 may first perform stereo matching of a left image and a right image in the frame image to obtain a binocular disparity map corresponding to the frame image. The binocular disparity map may have the same resolution as the resolution of the frame image.

For an arbitrary key frame of the binocular video, when determining the depth map corresponding to the key frame, the binocular depth estimation module 330 may perform stereo matching 331 directly on the left-eye image and the right-eye image in the corresponding key frame to obtain a binocular disparity map 332 corresponding to the key frame. For example, the binocular depth estimation module 330 may perform the stereo matching 331 through a binocular depth estimation network to obtain the binocular disparity map 332, and then may convert the obtained binocular disparity map 332 (described below) to obtain the depth map corresponding to the frame image.

However, the present disclosure is not limited thereto, and the performing of the stereo matching of the left-eye image and the right-eye image in the frame image to obtain the binocular disparity map corresponding to the frame image may include obtaining the binocular disparity map by performing stereo matching according to the high-density map corresponding to the previous key frame before the frame image and the left eye image and the right eye image of the frame image. Specifically, as shown in FIG. 3, the high-density map corresponding to the previous key frame before the frame image may be fed back to the binocular depth estimation module 330, and then the binocular depth estimation module 330 may perform the stereo matching 331 based on the high-density map corresponding to the previous key frame and the left image and right image in the current frame image to obtain the binocular disparity map 332 corresponding to the current frame image. Here, the high-density map corresponding to the previous key frame may be obtained by inputting the previous key frame into an implicit high-density map representation obtained through the neural high-density map module 340, which is described below. Subsequently, the binocular disparity map 332 may be converted into a depth map having more accurate scene structure information through a conversion operation to be described below. Thereafter, the corresponding depth map may be input to the neural high-density map module 340 so that the high-density map obtained by the neural high-density map module 340 has more accurate depth information.

Specifically, the electronic device 300 may obtain the corresponding depth map by converting the binocular disparity map through Equation 6 below.

$$z = \vert f / d \qquad Equation 6$$

Here, z denotes the depth, I denotes the distance between the optical centers of a binocular camera used to obtain the binocular video, d denotes a parallax, and f denotes a focal length of the binocular camera.

The execution order of operation 222 and the obtaining of the depth map corresponding to the frame image is not particularly limited, and the execution order may be interchanged.

The above descriptions are about the process of obtaining a depth map corresponding to a frame image, and operation 224 is described in detail below.

Specifically, operation 224 may include obtaining an implicit high-density map representation of a scene corresponding to the binocular video by training the neural network based on the result of the global optimization, the depth map corresponding to the frame image, and the frame image, and obtaining reliability of the high-density map and each 3D landmark point in the high-density map by inputting the optimized camera position and pose corresponding to the frame image to the obtained implicit high-density map representation.

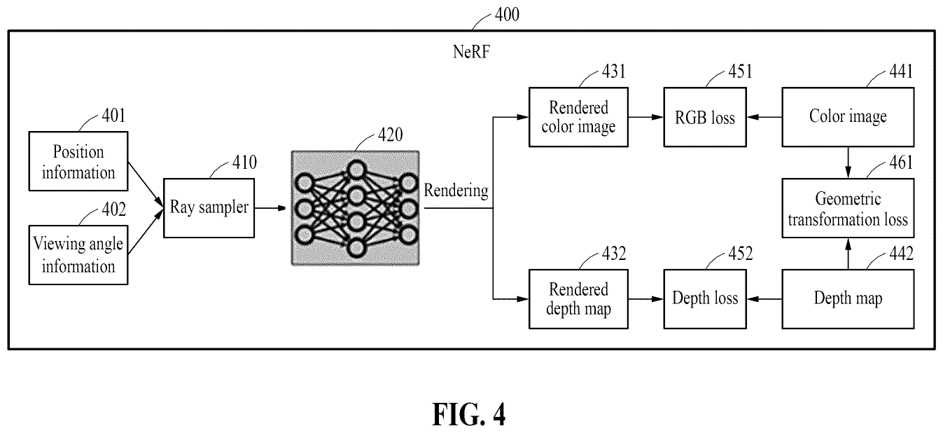

As shown in FIG. 3, for the currently input frame image, the sparse map module 320 may input not only the optimized camera position and pose of the frame image but also the frame image (i.e., a color image of the frame image) to the neural high-density map module 340. Accordingly, the binocular depth estimation module 330 may input the depth map corresponding to the corresponding frame image to the neural high-density map module 340. In this case, the neural network of the neural high-density map module 340 (hereinafter referred to as a NeRF) trains the scene corresponding to the binocular video online based on the received information and may implicitly express the scene to the network, thereby obtaining the implicit high-density map representation of the scene. Next, the training process of the NeRF is described with reference to FIG. 4.

FIG. 4 illustrates an example of a training method using a NeRF, according to one or more embodiments.

Referring to FIG. 4, the training method of the present disclosure may first obtain a rendered color image 431 and a rendered depth map 432 based on an optimized camera position and pose corresponding to a currently input frame image. Specifically, a ray sampler 410 may encode position information 401 and viewing angle information 402 of the optimized camera position and pose corresponding to the frame image, may obtain a hash encoding result corresponding to the position information 401 and a direction encoding result corresponding to the viewing angle information 402, and then, may input these encoding results into an implicit map network 420 (i.e., a NeRF network) to perform rendering, thereby obtaining the rendered color image 431 and the rendered depth map 432.

In addition, the training method of the present disclosure may determine a first loss function based on the rendered color image 431 and a color image 441 of the frame image. Specifically, the first loss function may represent an RGB loss 451 (L_{RGB} (T′, Θ₁)). The RGB loss 451 may be the L-1 norm between the rendered color image 431 and the color image 441 of the frame image and may be expressed as Equation 7 below.

$${L}_{RGB} ( T , {Θ}_{1} ) = ‖ I - {I}_{render} ( T , {Θ}_{1} ) ‖ \qquad Equation 7$$

Here, I denotes a color image of a frame image and I_{render} (T, Θ₁) denotes a rendered color image. That is, I_{render} (T, Θ₁) denotes a rendered color image corresponding to the camera position T and pose Θ₁, and Θ₁ denotes a parameter of an implicit map network (i.e., a NeRF network).

In addition, the training method of the present disclosure may determine a second loss function based on the rendered depth map 432 and a depth map 442 corresponding to the frame image. Specifically, the second loss function may represent a depth loss 452 L_{Depth} (T, Θ₁, Θ₂).

The depth loss 452 may be the L-1 norm between the rendered depth map 432 and the depth map 442 estimated by the binocular depth estimation module 230 of the frame image and may be expressed as Equation 8 below.

$${L}_{Depth} ( T , {Θ}_{1} , {Θ}_{2} ) = ‖ {D}_{Stereo} ( T , {Θ}_{2} ) - {D}_{render} ( T , {Θ}_{1} ) ‖ \qquad Equation 8$$

Here, Dₛₜₑᵣₑₒ (T, Θ₂) denotes a depth map corresponding to the frame image estimated by the binocular depth estimation module 230. That is, Dₛₜₑᵣₑₒ (T′, Θ₂) denotes a depth map corresponding to the frame image corresponding to the camera position T and pose Θ₂, and Θ₂ denotes a parameter of a depth estimation network of the binocular depth estimation module 230. D_{render} (T, Θ₁) denotes a rendered depth map, that is, the camera position and pose T and the rendered depth map corresponding to Θ₁.

In addition, the training method of the present disclosure may determine a third loss function based on the depth map 442 corresponding to the frame image and the color image 441 of the frame image. Specifically, the third loss function may represent a geometric transformation loss 461 I_{warp}(T, Θ₁, Θ₂) for calculating an RGB difference value of a corresponding point after transformation of another image. For example, when a pixel point qm=(u,v) of an m-th frame image is converted into an n-th frame image (here, u and v denote a horizontal coordinate and a vertical coordinate of the m-th frame image, respectively), the geometric transformation loss 461 may calculate a 3D coordinate of a pixel point qm based on the depth map estimated by the binocular depth estimation module 230 and a relative position and pose of the two frame images and then, may obtain a frame (Iwarp) after geometric transformation by projecting the pixel point to the n-th frame image. In the present disclosure, the third loss function may be calculated according to Equation 9 below.

$${L}_{warp} ( T , {Θ}_{1} , {Θ}_{2} ) = ‖ {I}_{warp} ( T , {Θ}_{1} , {D}_{stereo} ( T , {Θ}_{2} ) ) - I ( T , {Θ}_{1} ) ‖ \qquad Equation 9$$

Subsequently, the training method of the present disclosure may include training a neural network (e.g., using online training) based on a weighted sum of the first loss function, the second loss function, and the third loss function to obtain an implicit high-density map representation of a scene corresponding to a binocular video.

For example, the training method of the present disclosure may perform a weight sum of the first loss function, the second loss function, and the third loss function according to Equation 10 below to obtain a total loss function Lₜₒₜₐₗ(T, Θ₁, Θ₂) for training a NeRF network.

$${L}_{total} ( T , {Θ}_{1} , {Θ}_{2} ) = {L}_{RGB} ( T , {Θ}_{1} ) + {λ}_{D} * {L}_{Depth} ( T , {Θ}_{1} , {Θ}_{2} ) + {λ}_{w} * {L}_{warp} ( T , {Θ}_{1} , {Θ}_{2} ) \qquad Equation 10$$

In Equation 10, λ_{D} and λ_{w} are hyperparameters.

As described above, the electronic device 300 of some embodiments may obtain a network parameter of the NeRF network using total loss function minimization and accordingly, may obtain the implicit high-density map representation of the scene corresponding to the binocular video. In addition, when the camera position and pose of the current frame image are input to the implicit high-density map representation, the electronic device 300 of the present disclosure may obtain reliability of the high-density map corresponding to the frame image and each 3D landmark point in the high-density map. In addition, as described above, the electronic device 300 may feed the high-density map corresponding to the frame back to the binocular depth estimation module 330. The binocular depth estimation module 330 may perform stereo matching by combining the high-density map with a left image and a right image in a next key frame to obtain a binocular disparity map corresponding to the next key frame. The neural high-density map module 340 may receive the binocular disparity map and may convert the binocular disparity map into the depth map. The binocular depth estimation module 330 and the neural high-density map module 240 may be alternately and repeatedly updated to improve accuracy of a system and a model.

As described above, when the current frame image is a key frame, the electronic device 300 of the present disclosure may obtain a camera position and pose, a sparse map, and a high-density map corresponding to the frame image.

In addition, in an example of the present disclosure, when the frame image is the key frame, operation 120 may include updating the obtained sparse map based on the obtained high-density map and the reliability of each 3D landmark point in the high-density map. For example, when neural network optimization converges to obtain the implicit high-density map representation of the scene and when the electronic device 300 obtains the high-density map corresponding to the frame image and the reliability of each 3D landmark point in the high-density map, the electronic device 300 may update the obtained sparse map corresponding to the frame image to maintain one globally consistent sparse map over time.

Specifically, the updating of the sparse map may include, for one 3D landmark point in the sparse map, according to the reliability of the 3D landmark point corresponding to the one 3D landmark point in the high-density map, determining a first weight of the one 3D landmark point and a second weight of the 3D landmark point corresponding to the one 3D landmark point in the high-density map, based on the determined first weight and the determined second weight, obtaining the updated one 3D landmark point by fusing the one 3D landmark point with the 3D landmark point corresponding to the one 3D landmark point in the high-density map, and updating each 3D landmark point in the sparse map.

For example, the second weight of the 3D landmark point (corresponding to the one 3D landmark point of the sparse map in the high-density map) may be directly proportional to the reliability of the corresponding 3D landmark point.

Specifically, when the reliability of the 3D landmark point corresponding to the one 3D landmark point in the high-density map is high, the electronic device 300 may determine the second weight of the 3D landmark point corresponding to the one 3D landmark point in the high-density map to be a greater value and may determine the first weight of the one 3D landmark point in the sparse map to be a smaller value.

Specifically, when the reliability of the 3D landmark point corresponding to the one 3D landmark point in the high-density map is low, the electronic device 300 may determine the second weight of the 3D landmark point corresponding to the one 3D landmark point in the high-density map to be a smaller value and may determine the first weight of the one 3D landmark point in the sparse map to be a greater value. In another example, the electronic device 300 may determine the first weight of the one 3D landmark point in the sparse map and the second weight of the 3D landmark point corresponding to the one 3D landmark point in the high-density map, according to a result of comparing the reliability with a predetermined threshold value. However, the present disclosure is not limited thereto.

The electronic device 300 may determine the first weight of the one 3D landmark point in the sparse map and the second weight of the 3D landmark point corresponding to the one 3D landmark point in the high-density map, and then, may apply weights to and sum the 3D landmark points corresponding to the one 3D landmark point in the sparse map and the one 3D landmark point in the high-density map, according to the determined first weight and the determined second weight, to update the one 3D landmark point of the sparse map with the corresponding result.

Thereafter, the electronic device 300 may update each 3D landmark point of the sparse map in a similar method. This updated sparse map may be used as the final sparse map when the frame image is a key frame.

The process when the frame image is a key frame has been described, and when the frame image is a non-key frame (i.e., a normal frame), operations 230 and 232 may be executed. In other words, when the frame image is a non-key frame, operation 120 may include operations 230 and 232.

Specifically, in operation 230, the electronic device 300 may obtain the camera position and pose corresponding to the frame image based on the frame image and data of an IMU corresponding to the frame image. As shown in FIG. 3, the tracking module 310 may sequentially perform feature point detection and matching, IMU pre-integration, feature re-identification, and sliding window-based BA optimization based on the frame image and the data of the IMU corresponding to the frame image, and may thus obtain the camera position and pose corresponding to the non-key frame. This process is generally the same as operation 220 performed when the frame image is a key frame.

In operation 232, the electronic device 300 may determine the sparse map and the high-density map corresponding to a previous key frame before the frame image as the sparse map and the high-density map corresponding to the frame image.

Specifically, in an example of the present disclosure, unlike the key frame, since the non-key frame only performs camera position and pose estimation in the tracking module 310 and does not participate in calculations of other modules, the sparse map and the high-density map corresponding to the previous key frame before the frame image may be determined as the sparse map and the high-density map corresponding to the frame image, for the frame image that is the non-key frame. For example, when a current frame image is a 10th frame and the previous key frame before the frame image is the 8th frame, the electronic device 300 may determine the sparse map and the high-density map corresponding to the 8th frame obtained through operations 220 to 224 as the sparse map and the high-density map corresponding to the frame image.

The key frame and the non-key frame may be processed according to the method described above until all frames of a stereoscopic video have been processed.

Examples of the present disclosure also provide an electronic device including a processor, and optionally, may further include at least one transceiver and/or at least one memory coupled to at least one processor. The at least one processor may be configured to perform operations of the method provided in any optional example of the present disclosure.

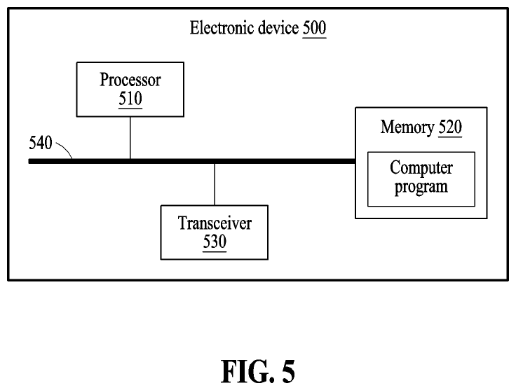

FIG. 5 illustrates an example of a structure of an electronic device on which examples and embodiments described above may be implemented.

Referring to FIG. 5, an electronic device 500 includes a processor 510 (one or more processors in practice) and a memory 520. The processor 510 may be connected to the memory 520, for example, through a bus 540. Optionally, the electronic device 500 may further include a transceiver 530.

The transceiver 530 may be used for data interaction between the electronic device 500 and other electronic devices, such as transmitting data and/or receiving data. It may be noted that in actual applications, the processor 510, the memory 520, and the transceiver 530 are not limited to one, and the structure of the corresponding electronic device 500 does not constitute a limitation to the examples of the present disclosure. Optionally, the electronic device 500 may be a first network node, a second network node, or a third network node.

The processor 510 may be a CPU, a general-purpose processor, a digital signal processor (DSP), an application-specific integrated circuit (ASIC), a field-programmable gate array (FPGA), or another programmable logic device, a transistor logic device, a hardware component, or any combination thereof. Various example logic blocks, modules, and circuits described herein may be implemented or executed. The processor 510 may also be a combination that realizes computing functions including, for example, a combination of one or more microprocessors and a combination of a DSP and a microprocessor.

The bus 540 may include a path for transmitting information between the components. The bus 540 may be a peripheral component interconnect (PCI) bus or an extended industry standard architecture (EISA) bus. The bus 540 may be classified into an address bus, a data bus, and a control bus. For ease of examples, only one thick line is shown in FIG. 5, but there may not be one bus or only one type of bus.

The memory 520 may be or include read-only memory (ROM) or another type of static storage device for storing static information and instructions, random-access memory (RAM) or another type of dynamic storage device for storing information and instructions, electrically erasable programmable-only memory (EEPROM), a compact disc read-only memory (CD-ROM), or another optical disc storage, an optical disc storage (including a compressive optical disc, a laser disc, an optical disc, a digital versatile disc (DVD), a Blu-ray disc, and the like), disk storage media, other magnetic storage devices, or another computer-readable medium that may be used to carry or store a computer program, but examples are not limited thereto.

The memory 520 is used to store a computer program and an instruction for executing the examples of the present disclosure and is controlled by the processor 510. The processor 510 may be configured to execute computer programs or instructions stored in the memory 520 and implement the operations of the methods described with reference to the examples herein.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as ROM, RAM, flash memory, and the like (but not signals per se). Examples of program instructions include both machine code, such as produced by a compiler, and files containing higher-level code that may be executed by the computer using an interpreter. The above-described devices may be configured to act as one or more software modules in order to perform the operations of the above-described examples, or vice versa.

The software may include a computer program, a piece of code, an instruction, or some combinations thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The computing apparatuses, the electronic devices, the processors, the memories, the image sensors, the displays, the information output system and hardware, the storage devices, and other apparatuses, devices, units, modules, and components described herein with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method performed by an electronic device, the method comprising:
obtaining a frame image of a video from a camera and data of an inertial measurement unit (IMU) corresponding to the frame image, the data of the IMU indicating inertial movement corresponding to the frame image; and
obtaining a camera position and pose of the camera, a sparse map, and a high-density map corresponding to the frame image, based on the frame image and the data of the IMU.

2. The method of claim 1, wherein the obtaining of the camera position and pose, the sparse map, and the high-density map corresponding to the frame image comprises:
in response to the frame image being a key frame,
obtaining the camera position and pose corresponding to the frame image, a three-dimensional (3D) landmark point, a speed of the IMU, and a deviation of the IMU, based on the frame image and the data of the IMU;
performing global optimization based on the camera position and pose corresponding to at least one key frame including the frame image, the 3D landmark point, the speed of the IMU, and the deviation of the IMU;
generating the sparse map corresponding to the frame image from an optimized 3D landmark point; and
obtaining the high-density map through a neural network, based on a result of the global optimization, a depth map corresponding to the frame image, and the frame image.

3. The method of claim 2, wherein the obtaining of the camera position and pose, the sparse map, and the high-density map corresponding to the frame image comprises:
based on the frame image being a non-key frame,
obtaining the camera position and pose of the frame image, based on the frame image and the data of the IMU corresponding to the frame image; and
determining the sparse map and the high-density map corresponding to a previous key frame before the frame image as the sparse map and the high-density map corresponding to the frame image.

4. The method of claim 2, wherein the performing of the global optimization based on the camera position and pose corresponding to at least one key frame including the frame image, the 3D landmark point, the speed of the IMU, and the deviation of the IMU comprises:
constructing a reprojection error function based on a robust kernel function, based on the camera position and pose corresponding to the at least one key frame and the 3D landmark point;
constructing an error function of the IMU, based on the camera position and pose corresponding to the at least one key frame, the speed of the IMU, and the deviation of the IMU; and
by minimizing a global optimization target function including the reprojection error function based on the robust kernel function and the error function of the IMU, obtaining an optimized camera position and pose corresponding to the at least one key frame, an optimized 3D landmark point, an optimized speed of the IMU, and an optimized deviation of the IMU.

5. The method of claim 4, wherein
the robust kernel function comprises a Huber kernel function.

6. The method of claim 1, wherein
the obtaining of the camera position and pose, the sparse map, and the high-density map corresponding to the frame image comprises, based on the frame image being a non-key frame, determining a depth map corresponding to the frame image.

7. The method of claim 6, wherein the determining of the depth map corresponding to the frame image comprises:
performing stereo matching on a left image and a right image of the frame image to obtain a binocular disparity map corresponding to the frame image; and
converting the binocular disparity map to obtain the depth map corresponding to the frame image.

8. The method of claim 7, wherein
the performing of the stereo matching on the left image and the right image of the frame image to obtain the binocular disparity map corresponding to the frame image comprises
obtaining the binocular disparity map by performing stereo matching according to a high-density map corresponding to a previous key frame before the frame image and the left image and the right image of the frame image.

9. The method of claim 2, wherein
the obtaining of the high-density map through the neural network, based on the result of the global optimization, the depth map corresponding to the frame image, and the frame image comprises:
obtaining an implicit high-density map representation of a scene corresponding to a binocular video by training the neural network based on the result of the global optimization, the depth map corresponding to the frame image, and the frame image; and
obtaining reliability of the high-density map and each 3D landmark point in the high-density map by inputting an optimized camera position and pose corresponding to the frame image to the obtained implicit high-density map representation.

10. The method of claim 9, wherein
the obtaining of the implicit high-density map representation of the scene corresponding to the binocular video by training the neural network based on the result of the global optimization, the depth map corresponding to the frame image, and the frame image comprises:
obtaining a rendered color image and a rendered depth map based on the optimized camera position and pose corresponding to the frame image;
determining a first loss function based on the rendered color image and a color image of the frame image;
determining a second loss function based on the rendered depth map and the depth map;
determining a third loss function based on the depth map and the color image of the frame image; and
obtaining the implicit high-density map representation of the scene by training the neural network based on a weight sum of the first loss function, the second loss function, and the third loss function.

11. The method of claim 1, wherein
the obtaining of the camera position and pose, the sparse map, and the high-density map corresponding to the frame image comprises:
based on the frame image being a key frame, updating the sparse map based on reliability of the high-density map and each 3D landmark point in the high-density map.

12. The method of claim 11, wherein the updating of the sparse map comprises:
for one 3D landmark point in the sparse map, according to reliability of a 3D landmark point corresponding to the one 3D landmark point in the high-density map, determining a first weight of the one 3D landmark point and a second weight of the 3D landmark point corresponding to the one 3D landmark point in the high-density map;
based on the determined first weight and the determined second weight, updating the one 3D landmark point by fusing the one 3D landmark point with the 3D landmark point corresponding to the one 3D landmark point in the high-density map; and
updating the sparse map by performing the determining of the first weight and the second weight and the updating of the one 3D landmark point, for each 3D landmark point in the sparse map.

13. A non-transitory computer-readable storage medium storing instructions that, when executed by a processor, cause the processor to perform the method of claim 1.

14. An electronic device comprising:
one or more processors; and
a memory storing instructions configured to cause the one or more processors to:
obtain a frame image of a video from a camera and inertia data of an inertial measurement unit (IMU) corresponding to the frame image; and
obtain a camera position and pose of the camera, a sparse map, and a high-density map corresponding to the frame image, based on the frame image and the inertia data of the IMU.

15. The electronic device of claim 14, wherein when executed by the one or more processors, the instructions cause the electronic device to:
in the obtaining of the camera position and pose, the sparse map, and the high-density map corresponding to the frame image, based on the frame image being a key frame:
obtain the camera position and pose corresponding to the frame image, a three-dimensional (3D) landmark point, a speed of the IMU, and a deviation of the IMU, based on the frame image and the inertia data of the IMU;
perform global optimization based on the camera position and pose corresponding to at least one key frame including the frame image, the 3D landmark point, the speed of the IMU, and the deviation of the IMU;
generate the sparse map corresponding to the frame image from an optimized 3D landmark point; and
obtain the high-density map through a neural network, based on a result of the global optimization, a depth map corresponding to the frame image, and the frame image.

16. The electronic device of claim 15, wherein, when executed by the one or more processors, the instructions cause the electronic device to:
in the obtaining of the camera position and pose, the sparse map, and the high-density map corresponding to the frame image, based on the frame image being a non-key frame,
obtain the camera position and pose of the frame image, based on the frame image and the inertia data of the IMU corresponding to the frame image; and
determine the sparse map and the high-density map corresponding to a previous key frame before the frame image as the sparse map and the high-density map corresponding to the frame image.

17. The electronic device of claim 15, wherein, when executed by the one or more processors, the instructions cause the electronic device to:
in the performing of the global optimization based on the camera position and pose corresponding to at least one key frame including the frame image, the 3D landmark point, the speed of the IMU, and the deviation of the IMU,
construct a reprojection error function based on a robust kernel function, based on the camera position and pose corresponding to the at least one key frame and the 3D landmark point;
construct an error function of the IMU, based on the camera position and pose corresponding to the at least one key frame, the speed of the IMU, and the deviation of the IMU; and
by minimizing a global optimization target function including the reprojection error function based on the robust kernel function and the error function of the IMU, obtain an optimized camera position and pose corresponding to the at least one key frame, an optimized 3D landmark point, an optimized speed of the IMU, and an optimized deviation of the IMU.

18. The electronic device of claim 14, wherein, when executed by the at least one processor, the instructions cause the electronic device to:
in the obtaining of the camera position and pose, the sparse map, and the high-density map corresponding to the frame image, based on the frame image being a non-key frame,
perform stereo matching on a left eye image and a right eye image of the frame image to obtain a binocular disparity map corresponding to the frame image; and
convert the binocular disparity map to obtain the depth map corresponding to the frame image.

19. The electronic device of claim 15, wherein, when executed by the at least one processor, the instructions cause the electronic device to:
in the obtaining of the high-density map through the neural network, based on the result of the global optimization, the depth map corresponding to the frame image, and the frame image:
obtain an implicit high-density map representation of a scene corresponding to a binocular video by training the neural network based on the result of the global optimization, the depth map corresponding to the frame image, and the frame image; and
obtain reliability of the high-density map and each 3D landmark point in the high-density map by inputting an optimized camera position and pose corresponding to the frame image to the obtained implicit high-density map representation.

20. The electronic device of claim 14, wherein, when executed by the one or more processors, the instructions cause the electronic device to:
in the obtaining of the camera position and pose, the sparse map, and the high-density map corresponding to the frame image, and based on the frame image being a key frame:
for one 3D landmark point in the sparse map, according to reliability of a 3D landmark point corresponding to the one 3D landmark point in the high-density map, determine a first weight of the one 3D landmark point and a second weight of the 3D landmark point corresponding to the one 3D landmark point in the high-density map;
based on the determined first weight and the determined second weight, update the one 3D landmark point by fusing the one 3D landmark point with the 3D landmark point corresponding to the one 3D landmark point in the high-density map; and
update the sparse map by performing the determining of the first weight and the second weight and the updating of the one 3D landmark point, for each 3D landmark point in the sparse map.
